(19) United States
(12) Patent Application Publication
(10) Pub. No.: US 2006/0251866 A1
(43) Pub. Date: Nov. 9, 2006

(54) Electrophotographic medium composition

(76) Inventors: Xiaoqi Zhou, San Diego, CA (US); Lisa A. Underwood, Boise, ID (US); Richard J. McManus, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/122,543

(22) Filed: May 5, 2005

(51) Int. Cl. G03G 7/00

(52) U.S. Cl. 428/195.1

(57) ABSTRACT

An electrophotographic medium composition is disclosed. The composition includes a friction-controlling agent and an ionic conduction aid mixed together.

The present disclosure relates generally to electrophotographic printing medium compositions, and more particularly to an electrophotographic medium composition including a friction-controlling agent and a charge controlling agent.

Electrophotographic printing involves a device that has a media transportation system. Generally, a single sheet of media is picked up from a storage tray and then delivered to a photoreceptor/transfer belt and fuser to complete an imaging procedure. Advanced color electrophotographic printing devices are generally equipped with different color toner cartridges and a duplexer, which makes it possible to duplex images on both sides of a single sheet. The incorporation of a duplexer may, in some instances, involve more complex media passes. The transportation system inside such a printing device may include a higher possibility for media “jam.”

Media “jam” includes a variety of potential problems that may result during media transportation. The “no pick” jam may result when a pick-up roller or a vacuum belt of the device fails to move a sheet from the media tray. “Multiple-pick up” jam may result when more than one sheet is picked up from the storage tray at one time. “Skewing jam” may result from media misalignment in the media pass. Input-tray jam, output-tray jam, registration jam, belt jam, or fuser jam may result when problems arise in the particular location (e.g. the input-tray) in the device. Each of the jams may, in some instances, create poor printing quality, shut-down of the printing device, and/or potential damage of the device. The previously described “jams” may, in some instances, be a result of the design of the media pass, the material choice of the media, the printing parameters, the environmental or media storage parameters, and/or combinations thereof.

Further, coated papers used to create superior image effects in color electrophotographic printing may, in some cases, be more problematic to achieve good running ability or sheet-feeding (i.e. less paper jams) during high speed color electrophotographic printing.

As such, it would be desirable to provide an electrophotographic medium composition that provides sheet running ability such that jams in the device are substantially prevented or lessened.

### SUMMARY

An electrophotographic medium composition is disclosed. The composition includes a friction-controlling agent and an ionic conduction aid mixed together.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is a schematic view of an embodiment of a system for electrophotographic printing; and

FIG. 2 is a schematic view of an alternate embodiment of a system for electrophotographic printing.

### DETAILED DESCRIPTION

Embodiment(s) of the electrophotographic printing medium composition are suitable for establishment as a coating on a substrate. The coated substrate may be advantageously used in many applications, one example of which is high-speed color electrophotographic printing. Without being bound to any theory, it is believed that friction control agent(s), in combination with electrostatic charge control and base stock stiffness control, provide a printing media with good running ability in high-speed electrophotographic printing devices over a wide range of environmental conditions.

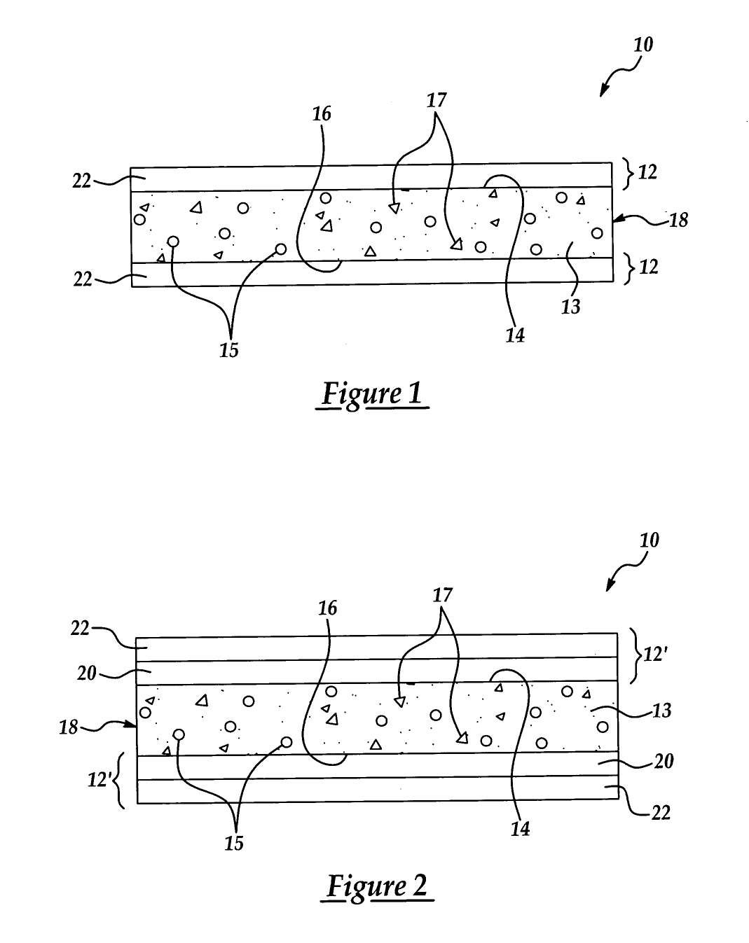

Referring now to FIG. 1, an embodiment of a system 10 for electrophotographic printing is shown. The system 10 includes an embodiment of the electrophotographic printing medium composition 12 established on opposed sides 14, 16 of substrate 18.

In an embodiment, the substrate 18 is paper. The paper may be made of a fabric stock having a weight ranging from about 60 gram/m² (gsm) to about 300 gsm. In a non-limitative example, the weight ranges from about 70 gsm to about 200 gsm.

The paper substrate 18 may also include any suitable wood or non-wood pulp 13. Non-limitative examples of suitable pulps 13 include groundwood pulp, sulfite pulp, chemically ground pulp, refiner ground pulp, thermomechanical pulp, and/or mixtures thereof. Fillers 15 may also be incorporated into the pulp 13, for example, to substantially control physical properties of the final coated paper. Examples of the fillers 15 include, but are not limited to ground calcium carbonate, precipitated calcium carbonate, titanium dioxide, kaolin, clay, silicates, and/or mixtures thereof. It is to be understood that any desirable amount of filler 15 may be used. In one embodiment, the amount of filler 15 ranges from about 0 wt. % to about 20 wt. % of the substrate 18, and in another embodiment, the amount of filler 15 ranges from about 5 wt. % to about 15 wt. % of the substrate 18.

In preparation of the substrate 18 (e.g. paper stock), internal and surface sizing may be desired. This process may advantageously improve internal bond strength of the substrate 18 fibers, and may also advantageously control the resistance of the coated substrate 18 to wetting, penetration, and absorption of aqueous liquids (a non-limitative example of which includes moisture vapor that may contribute to multiple pick-up jams in high humidity conditions). Internal sizing may be accomplished by adding a sizing agent 17 to the substrate 18 in wet end. Non-limitative examples of suitable sizing agents 17 include rosin-based sizing agent(s), wax-based sizing agent(s), cellulose-reactive sizing agent(s) and other synthetic sizing agent(s), and/or mixtures thereof. It is to be understood that the type and amount of surface sizing agent(s) may substantially improve moisture resistance and may alter the stiffness of the base paper stock.

Surface sizing (i.e. apply sizing agent to the formatted paper roll) may be accomplished by film size press, pond size press and other surface techniques.

The stiffness of the paper stock 18 may be related, at least in part, to the paper thickness. It is to be understood that with substantially the same pulp and filler composition, the thinner the paper caliper is, the lower the paper stiffness will be. In order to achieve enhanced running ability, the stiffness of the paper stock 18, or its flexural rigidity may be controlled, in part because the stiffness of the final system 10 may be dependant upon the stiffness of paper stock 18. The stiffness may be determined, at least in part, by the physical properties and composition of fibers in the pulp 13 and the percentage of fibers to fillers 15. A method such as TAPPI T489OM-92, using a Taber-type stiffness tester, may be used to determine the stiffness of the paper stock 18 and the system 10.

In an embodiment, a low jam rate (less than about 1 jam for every 1000 running sheets) in high-speed duplex printing may be obtained with an example embodiment stiffness of the paper and the system 10 ranging from about 1 Taber stiffness units (gram centimeter) to about 25 Taber stiffness units in the paper machine direction, and ranging from about 1 Taber stiffness units and about 15 Taber stiffness units in the paper cross machine direction. In another embodiment, the system 10 stiffness ranges from about 2 Taber stiffness units to about 18 Taber stiffness units in the paper machine direction, and from about 1.5 Taber stiffness units to about 10 Taber stiffness units in the paper cross machine direction.

Generally, extreme (high or low) temperature and humidity conditions may contribute to paper jams in printing devices. For example, the color electrophotographic printers running at 10° C. and 15% relative humidity and running at 30° C. and 80% relative humidity generally show higher jam rates than those running at conventional conditions of 23° C. and 50% relative humidity. Without being bound to any theory, it is believed that in the case of low temperature and low relative humidity conditions, the electrostatic charge will build up excessively on the media surface. This electrostatic force may stick two or more paper sheets together to initialize the multi-pick jam. Lower electrical surface and volume resistivity values may advantageously assist in rapid release of the electrostatic charges. However, lower resistivity values may, in some instances, result in a problem with the efficiency of toner transfer, which may lower color density of the printed image.

As such, it has been found that an optimized electrical surface and volume resistivity are desirable. In an embodiment in which the environment is 23° C. and 50% humidity, the surface resistivity may desirably range from about 7×10⁸ to 5×10¹⁰ OHM/square and alternately may desirably range from about 1.0×10⁹ to about 8.0×10⁹ OHM/square. In this same environment, the volume resistivity may desirably range from about 5.0×10⁸ to 1.0×10¹² OHM cm, and alternately may desirably range from about 1.0×10⁹ to 5.0×10¹⁰ OHM cm. In an alternate embodiment where the temperature and humidity is lower than 15° C. and 10%, respectively, the surface resistivity ranges from about 5.0×10¹² to about 1.0×015 OHM/square, and alternately from about 7.0×10¹² to 1.0×10¹⁴ OHM/square; while the volume resistivity ranges from about 1.0×10¹³ to about 1.0×10¹⁵ OHM cm, and alternately from about 5.0×10¹³ to about 5.0×10¹⁴ OHM cm. Typical paper stocks and surface coating formulations generally have higher electrical resistivity than the values according to the embodiment(s) herein.

Embodiment(s) of the electrophotographic medium composition 12 include a friction controlling agent and an ionic conduction aid, which make up an image-receiving layer 22. It is to be understood that any suitable ionic conduction aid may be used. In an embodiment, the ionic conduction aid is an inorganic electrolyte or an organic electrolyte. It is to be understood that the electrolytes may advantageously assist in controlling the electrical resistivity of the composition 12 and of the system 10. Non-limitative examples of suitable electrolytes include sodium chloride, potassium chloride, sodium sulfate, potassium sulfate, quaternary ammonium salts, polymeric electrolytes, sodium salts of polystyrene sulfonates, ammonium salts of polystyrene sulfonates, sodium salts of polyacrylates, ammonium salts of polyacrylates, sodium salts of polymethacrylates, ammonium salts of polymethacrylates, sodium salts of polyvinyl sulfonates, ammonium salts of polyvinyl sulfonates, sodium salts of polyvinyl phosphates, ammonium salts of polyvinyl phosphates, and/or combinations thereof.

In the high temperature and high relative humidity conditions (such as 30° C. and 80% relative humidity), moisture enters the gaps between sheets in a media stack and is absorbed either inside coating layer(s) and base stock, or on the surface of the outermost layer of the coated paper. Due, at least in part, to the difference in the equilibrium of the water pressure between the surface and the air, the sheets may adhere together. To substantially control the moisture level on the media surface and to reduce surface tension, the composition 12 (e.g. image-receiving layer 22) also includes a friction-controlling agent as well as a charge control agent (i.e. the previously mentioned ionic conduction aid). The friction-controlling agent may be in a physical form of polymeric emulsions, polymer dispersions, or combinations thereof. In another embodiment, the friction-controlling agent may be in a physical form of polymeric powders. Non-limitative examples of the friction-controlling agent include carnauba wax, montan wax, paraffin wax, microcrystalline waxes from the distillation of crude oil, synthetic polymers and/or combinations thereof.

Examples of synthetic polymers include, but are not limited to those having a polyolefin backbone structure, such as, for example high density polyethylene, low density polyethylene, polypropylene, and polybutene. Other examples of synthetic polymers include polymeric hydrohalocarbon compounds and polymeric hydrofluoro compounds such as polytetrafluoroethylene.

Aside from the friction-controlling agent and charge control agent (ionic conducting agent) described above, the image-receiving layer 22 may contain other chemical components such as inorganic pigments, polymeric binders, and special functional coating additives.

Inorganic pigments include particulates in a powder or slurry form. Non-limitative examples of such materials include titanium dioxide, hydrated alumina, calcium carbonate, barium sulfate, silica, clay, alumino silicates, alumina, boehmite, pseudoboehmite, zinc oxide, and combinations thereof.

Polymeric binder generally refers to a polymer composition used to provide adhesion between the inorganic particles and other components within the image-receiving layer 22. Binders may also provide adhesion between the image-receiving layer 22 and other established layers (such as base coating layer 20 as shown in FIG. 2). In an embodiment, the binders may be a water soluble polymer or water dispersible polymeric latex. Non-limitative examples of suitable binders include styrene butadiene coplymer, polyacrylates, polyvinylacetates, polyacrylic acids, polyesters, polyvinyl alcohol, polystyrene, polymethacrylates, polyacrylic esters, polymethacrylic esters, polyurethanes, copolymers thereof, and combinations thereof.

It is to be understood that when sheet stiffness and the sheet edge quality resulting from sheet converting processing is in the range of the embodiment(s) herein, the sheet running ability may be characterized by the coefficient of friction (COF) of sheet to sheet, and sheet to rubber (if a rubber pick up roller is used for paper pick-up). The COF is an integrated parameter indicating the chemical and physical properties of the media, examples of which include, but are not limited to surface polarity, surface smoothness, air permeability, moisture level of the media, and the like. In an embodiment, the sheet-to-sheet static COF in 23° C. and 50% humidity ranges from about 0.30 to about 0.55, and alternately from about 0.35 to about 0.50, and the sheet-to-sheet kinetic COF in 23° C. and 50% humidity ranges from about 0.15 to about 0.50, and alternately from about 0.20 to about 0.45. Without being bound to any theory, it is believed that too high or too low (i.e. outside of the ranges of the embodiment(s) herein) of a COF may, in some instances, cause either multiple jams or “no pick” jams.

The addition of the friction-controlling agent in the image-receiving layer 22 may advantageously assist in maintaining the COF of the system 10 in the desired embodiment range. In a non-limitative example, a non-polar hydrocarbon synthetic polymer emulsion or dispersion, such as high density or low density polyethylene is used. Suitable examples of polyethylenes include MICHEM Emulsion, MICHEM Lube, and MICHEM Shield, all of which are commercially available from Michelman Inc. located in Cincinnati, Ohio. The friction-controlling agents may act as lubricants, anti-slipping agents, and water resistant agents so that value of COF is controlled in the optimum range and the variation of COF value with environmental changes may be substantially advantageously minimized. In this embodiment, the friction-controlling agent is in the form of an emulsion or dispersion with a mean particle diameter ranging from about 0.1 microns to about 1 micron, and in another embodiment ranging from about 0.3 microns to about 0.5 microns. In this example embodiment, the amount of the friction-controlling agent in the image-receiving layer 22 ranges between about 0.2 parts by weight and about 2 parts by weight based on 100 parts of dry weight of the pigment in the layer 22.

In another example embodiment, the friction-controlling agent is a synthetic polymer with a high molecular weight and a solid micro-particle physical form, such as, for example high density polyethylene powder. In this example, the particle size of the friction-controlling agent ranges between about 1 microns and about 20 microns, and alternately between about 5 microns and about 10 microns. In a particular example using polyolefins, the friction-controlling particles are hydrocarbon backbone polymers with an average molecular weight ranging from about 300,000 to about 600,000.

In an embodiment, the amount of friction controlling agent in the image-receiving layer 22 ranges from about 0.5 parts by weight to about 5 parts by weight, and alternately from about 0.7 parts by weight to about 2.0 parts by weight based on 100 parts by weight of dry inorganic pigments.

It is to be understood that the friction-controlling agent (for example, in its powder form) may be selected, at least in part, based on its mechanical properties. In an embodiment, the modulus of elasticity (as measured by the method ASTM D790) may range between about 180 MPa and about 300 MPa, while Shore hardness may range between about 40 and about 60 (as measured by the ASTM D 2240 method). Further, the melting point of the friction-controlling agent generally ranges between about 50° C. and about 150° C. In an example embodiment, the melting point ranges between about 90° C. and about 130° C.

Referring now to FIG. 2, the system 10 may optionally include a base coating layer 20 established between the image-receiving layer 22 and the side(s) 14, 16 of the substrate 18 upon which the image-receiving layer 22 is established. As such, the composition 12′, as shown in FIG. 2, includes the image-receiving layer 22 and the base coating layer 20. In an embodiment, the base coating layer 20 includes an ionic conduction aid, such as, for example, the inorganic and organic electrolytes described hereinabove. The base coating 20 may also include polymeric binders and inorganic pigments, such as those described herein.

Still further, small amounts of coating additives may be present in either or both of the coating 20 and the image-receiving layer 22. Such additives include, but are not limited to dyes to control paper color, optical brighteners, surfactants, rheological modifiers, cross-linking agents, defoamers, and/or dispersing agents, and or combinations thereof.

In an embodiment of the method of making a system 10, the image-receiving layer(s) 22 are established on one or both of the opposed sides 14, 16 of the substrate 12. In an alternate embodiment, the base coating layer(s) 20 are established on one or both of the opposed sides 14, 16 of the substrate 18, and the image-receiving layers 22 are established on each of the coating layers 20. It is to be understood that the optional coating layers 20 and the image-receiving layers 22 may be established via any suitable method. In an embodiment, the layers 20, 22 are established via a deposition or manufacturing method. Some non-limitative examples of suitable deposition techniques/manufacturing processes include roll-coating, conventional slot-die processing, blade coating, bent blade coating, rod coating, shear roll coating, slot-die cascade coating, pond coating, curtain coating and/or other comparable methods including those that use circulating and non-circulating coating technologies. In certain instances, spray-coating, immersion-coating, and/or cast-coating techniques may be suitable for depositing.

Further, although the optional coating layer 20 and image-receiving layer 22 are shown in FIG. 2 on both sides 14, 16 of substrate 18 (forming a five-layer system), it is to be understood that the image-receiving layer 22, with or without the coating layer 20, may be on one side 14 or 16 of substrate 18, if desired. In still a further embodiment, the image-receiving layer 22 may be established directly on the substrate 18 on a side 16, 14 opposed the side 14, 16 the layer(s) 20, 22 are established.

It is to be understood that the coating 20, when present, and/or the image-receiving layer 22 may be established at any desirable thickness. In an embodiment, the thickness of each layer 20, 22 ranges from about 5 μm to about 30 μm, and in an alternate embodiment, each layer 20, 22 thickness ranges from about 8 μm to about 15 μm.

The optional base coating 20 and the image-receiving layers 22 may be applied in one or more layers simultaneously, with a coat weight ranging from about 5 g/m² to about 30 g/m², or alternately from about 8 g/m² to about 15 g/m², for each layer 20, 22 on each side 14, 16. In one embodiment, the solid content of the coating colors (i.e. the coating in its liquid state, prior to coating and drying) used to form of each of the layers 20, 22 ranges from about 60 wt % to about 75 wt %. The viscosity of the coating color used to form each layer 20, 22 ranges from about 300 cps to about 1500 cps as measured by a low shear Brookfield viscometer at a speed of 100 rpm, or from about 30 cps to about 40 cps at a higher shear rate of 4500 rpm using a high shear Hercules viscometer.

It is to be understood that once the layer(s) 22 (and optionally 20) are established, they may be dried by convection, conduction, infrared radiation, atmospheric exposure, or other like methods. Further, once the layer(s) 22 (and optionally 20) are applied as desired, a calendering process may be used to achieve desired gloss or surface smoothness. The calendering device may be a separate super calendering machine, an on-line soft nip calendering unit, an off-line soft nip calendering machine, or the like.

Embodiment(s) of the electrophotographic medium composition 12, 12′ and the system 10 include, but are not limited to the following advantages. The composition 12, 12′ may be established on a substrate 18 which may be used in high-speed color electrophotographic printing. Without being bound to any theory, it is believed that the one or a combination of the friction control agent(s), substrate 18 stiffness control, and electrostatic charge control via ionic conduction aids, provides a printing media with good running ability in high-speed electrophotographic printing devices over a wide range of environmental conditions.

While several embodiments of the disclosure have been described in detail, it will be apparent to those skilled in the art that the disclosed embodiments may be modified. Therefore, the foregoing description is to be considered exemplary rather than limiting.

What is claimed is:

1. A system for electrophotographic printing, the system comprising:
a substrate; and
an image-receiving layer established on at least one side of the substrate, the image-receiving layer having at least one friction-controlling agent and at least one ionic conduction aid therein.

2. The system as defined in claim 1 wherein a coating layer is established between the image-receiving layer and the at least one side of the substrate, the coating layer having at least one ionic conduction aid therein.

3. The system as defined in claim 2 wherein at least one of the coating layer and the image-receiving layer has a thickness ranging from about 5 μm to about 30 μm.

4. The system as defined in claim 2 wherein a second coating layer is established on a side opposed to the at least one side of the substrate, and wherein a second image-receiving layer is established on the second coating, thereby forming a five-layer system.

5. The system as defined in claim 2 wherein the ionic conduction aid comprises an organic or an inorganic electrolyte, and wherein the coating layer further includes at least one of inorganic pigments and polymeric binders.

6. The system as defined in claim 5 wherein the inorganic pigments include at least one of clays, calcium carbonate, titanium dioxide, aluminum trihydrate, silica, alumino silicates, alumina, boehmite, pseudoboehmite, titanium dioxide, barium sulfate, zinc oxide, and combinations thereof.

7. The system as defined in claim 5 wherein the polymeric binders include at least one of styrene butadiene, polyacrylates, polyvinylacetates, polyacrylic acids, polyesters polyvinyl alcohol, polystyrene, polymethacrylates, polyacrylic esters, polymethacrylic esters, polyurethanes, copolymers thereof, and mixtures thereof.

8. The system as defined in claim 1 wherein the substrate is paper.

9. The system as defined in claim 1 wherein the system has a stiffness ranging from about 1 Taber unit to about 25 Taber units in a paper machine direction and from about 1 Taber unit to about 15 Taber units in a cross machine direction.

10. The system as defined in claim 1 wherein the system has a sheet-to-sheet static coefficient of friction ranging from about 0.30 to about 0.55, at about 23° C. and about 50% humidity.

11. The system as defined in claim 1 wherein the system has a sheet-to-sheet kinetic coefficient of friction ranging from about 0.15 to about 0.50, at about 23° C. and about 50% humidity.

12. The system as defined in claim 1 wherein the ionic conduction aid comprises an organic or an inorganic electrolyte, and wherein the image-receiving layer further includes at least one of inorganic pigments and polymeric binders.

13. The system as defined in claim 12 wherein the inorganic pigments include at least one of clays, calcium carbonate, titanium dioxide, aluminum trihydrate, silica, alumino silicates, alumina, boehmite, pseudoboehmite, titanium dioxide, barium sulfate, zinc oxide, and combinations thereof.

14. The system as defined in claim 12 wherein the polymeric binders include at least one of styrene butadiene, polyacrylates, polyvinylacetates, polyacrylic acids, polyesters polyvinyl alcohol, polystyrene, polymethacrylates, polyacrylic esters, polymethacrylic esters, polyurethanes, copolymers thereof, and mixtures thereof.

15. The system as defined in claim 1 wherein the ionic conduction aid comprises an inorganic or an organic electrolyte, and wherein the electrolyte is at least one of sodium chloride, potassium chloride, sodium sulfate, potassium sulfate, quaternary ammonium salts, polymeric electrolytes, sodium salts of polystyrene sulfonates, ammonium salts of polystyrene sulfonates, sodium salts of polyacrylates, ammonium salts of polyacrylates, sodium salts of polymethacrylates, ammonium salts of polymethacrylates, sodium salts of polyvinyl sulfonates, ammonium salts of polyvinyl sulfonates, sodium salts of polyvinyl phosphates, ammonium salts of polyvinyl phosphates, and combinations thereof.

16. The system as defined in claim 1 wherein the friction-controlling agent is in the form of one of polymeric emulsions, polymeric dispersions, polymeric powders, and combinations thereof.

17. The system as defined in claim 1 wherein the friction-controlling agent is one of carnauba wax, montan wax, paraffins, synthetic polymers, hydrohalocarbon compounds, hydrofluoro compounds, or combinations thereof.

18. The system as defined in claim 17 wherein the synthetic polymers are one of polyethylenes, polybutadienes, polypropylenes, paraffin oligomers, or mixtures thereof.

19. The system as defined in claim 17 wherein the hydrofluoro compounds include polytetrafluroethylene (PTFE) particles.

20. The system as defined in claim 1 wherein the friction-controlling agent includes non-polar hydrocarbon synthetic particles having a diameter ranging from about 0.1 microns to about 1 micron.

21. The system as defined in claim 20 wherein an amount of the non-polar hydrocarbon synthetic particles present in the image receiving layer ranges from about 0.2 parts by weight to about 2 parts by weight based on 100 parts by weight of dry inorganic pigments.

22. The system as defined in claim 20 wherein the friction-controlling agent comprises polyethylenes.

23. The system as defined in claim 1 wherein the friction-controlling agent includes synthetic particles, each particle having a molecular weight ranging from about 300,000 to about 600,000 and a diameter ranging from about 1 micron to about 20 microns.

24. The system as defined in claim 23 wherein the friction-controlling agent comprises polyolefins.

25. The system as defined in claim 23 wherein an amount of the synthetic particles present in the image-receiving layer ranges from about 0.5 parts by weight to about 5 parts by weight based on 100 parts by weight of dry pigment.

26. The system as defined in claim 1 wherein the ionic conduction aid is adapted to substantially control electrical resistivity of the system.

27. The system as defined in claim 26 wherein the resistivity is controlled to a surface resistivity ranging from about 7×10⁸ OHM/square to about 5×10¹⁰ OHM/square and a volume resistivity ranging from about 5.0×10⁸ OHM cm to about 1.0×10¹² OHM cm, at about 23° C. and about 50% relative humidity.

28. The system as defined in claim 26 wherein the resistivity is controlled to a surface resistivity ranging from about 5×10¹² OHM/square to about 1×10¹⁵ OHM/square and a volume resistivity ranging from about 1.0×10¹³ OHM cm to about 1.0×10¹⁵ OHM cm, at about 15° C. and about 10% relative humidity.

29. An electrophotographic medium composition, comprising:
a friction-controlling agent; and
an ionic conduction aid mixed with the friction-controlling agent.

30. The electrophotographic medium composition as defined in claim 29 wherein the friction-controlling agent and the ionic conduction aid form a first layer and wherein the composition further comprises a second layer including an ionic conduction aid and at least one of inorganic pigments and polymeric binders.

31. The electrophotographic medium composition as defined in claim 29, further comprising at least one of inorganic pigments and polymeric binders.

32. The electrophotographic medium composition as defined in claim 29 wherein the ionic conduction aid comprises an inorganic or an organic electrolyte, and wherein the electrolyte is at least one of sodium chloride, potassium chloride, sodium sulfate, potassium sulfate, quaternary ammonium salts, polymeric electrolytes, sodium salts of polystyrene sulfonates, ammonium salts of polystyrene sulfonates, sodium salts of polyacrylates, ammonium salts of polyacrylates, sodium salts of polymethacrylates, ammonium salts of polymethacrylates, sodium salts of polyvinyl sulfonates, ammonium salts of polyvinyl sulfonates, sodium salts of polyvinyl phosphates, ammonium salts of polyvinyl phosphates, and combinations thereof.

33. The electrophotographic medium composition as defined in claim 29 wherein the friction-controlling agent is in the form of polymeric emulsions, polymeric dispersions, polymeric powders, or combinations thereof.

34. The electrophotographic medium composition as defined in claim 29 wherein the friction-controlling agent is one of carnauba wax, montan wax, paraffins, synthetic polymers, hydrohalocarbon compounds, hydrofluoro compounds, or combinations thereof.

35. The electrophotographic medium composition as defined in claim 34 wherein the synthetic polymers are one of polyethylenes, polybutadienes, polypropylenes, paraffin oligomers, or mixtures thereof.

36. The electrophotographic medium composition as defined in claim 34 wherein the hydrofluoro compounds include polytetrafluroethylene (PTFE) particles.

37. The electrophotographic medium composition as defined in claim 29 wherein the ionic conduction aid is adapted to substantially control electrical resistivity.

38. The electrophotographic medium composition as defined in claim 37 wherein the resistivity is controlled to a surface resistivity ranging from about 7×10⁸ OHM/square to about 5×10¹⁰ OHM/square and a volume resistivity ranging from about 5.0×10⁸ OHM cm to about 1.0×10¹² OHM cm, at about 23° C. and about 50% relative humidity.

39. The electrophotographic medium composition as defined in claim 29 wherein the friction-controlling agent includes non-polar hydrocarbon synthetic particles having a diameter ranging from about 0.1 microns to about 1 micron.

40. The electrophotographic medium composition as defined in claim 39 wherein the friction-controlling agent comprises polyethylenes.

41. The electrophotographic medium composition as defined in claim 29 wherein the friction-controlling agent includes synthetic particles, each particle having a molecular weight ranging from about 300,000 to about 600,000 and a diameter ranging from about 1 micron to about 20 microns.

42. The electrophotographic medium composition as defined in claim 41 wherein the friction-controlling agent comprises polyolefins.

43. A method of making an electrophotographic medium system, the method comprising:
providing a substrate having two opposed sides; and
establishing an image-receiving layer on at least one of the two opposed sides of the substrate, the image-receiving layer including a friction-controlling agent and an electrolyte therein.

44. The method as defined in claim 43, further comprising establishing a coating layer between the image-receiving layer and the at least one of the two opposed sides of the substrate, the coating layer having an electrolyte therein.

45. The method as defined in claim 44 wherein, prior to establishing the coating layer between the image-receiving layer and the at least one of the two opposed sides of the substrate, the method further includes mixing the at least one electrolyte with at least one of inorganic pigments and polymeric binders to form the coating layer.

46. The method as defined in claim 43 wherein the substrate is paper.

47. The method as defined in claim 43 wherein the system has a sheet-to-sheet static coefficient of friction ranging from about 0.30 to about 0.55, at about 23° C. and about 50% humidity.

48. The method as defined in claim 43 wherein the system has a sheet-to-sheet kinetic coefficient of friction ranging from about 0.15 to about 0.50, at about 23° C. and about 50% humidity.

49. The method as defined in claim 43 wherein, prior to establishing the image-receiving layer on the at least one of the two opposed sides of the substrate, the method further includes mixing the friction-controlling agent and the electrolyte with at least one of inorganic pigments and polymeric binders to form the image-receiving layer.

50. The method as defined in claim 43 wherein the electrolyte is at least one of sodium chloride, potassium chloride, sodium sulfate, potassium sulfate, quaternary ammonium salts, polymeric electrolytes, sodium salts of polystyrene sulfonates, ammonium salts of polystyrene sulfonates, sodium salts of polyacrylates, ammonium salts of polyacrylates, sodium salts of polymethacrylates, ammonium salts of polymethacrylates, sodium salts of polyvinyl sulfonates, ammonium salts of polyvinyl sulfonates, sodium salts of polyvinyl phosphates, ammonium salts of polyvinyl phosphates, and combinations thereof.

51. The method as defined in claim 43 wherein the friction-controlling agent is at least one of carnauba wax, montan wax, paraffins, synthetic polymers, hydrohalocarbon compounds, hydrofluoro compounds, and combinations thereof.

52. The method as defined in claim 43 wherein the friction-controlling agent includes non-polar hydrocarbon synthetic particles having a diameter ranging from about 0.1 microns to about 1 micron.

53. The method as defined in claim 43 wherein the friction-controlling agent includes synthetic particles, each particle having a molecular weight ranging from about 300,000 to about 600,000 and a diameter ranging from about 1 micron to about 20 microns.

54. The method as defined in claim 43 wherein the establishing is accomplished by blade coating, bent blade coating, rod coating, shear roll coating, curtain coating, slot die coating, pond coating, or cast coating methods.

55. The method as defined in claim 43 wherein the electrolyte is adapted to substantially control electrical resistivity of the system.

56. The method as defined in claim 55 wherein the resistivity is controlled to a surface resistivity ranging from about 7×10⁸ OHM/square to about 5×10¹⁰ OHM/square and a volume resistivity ranging from about 5.0×10⁸ OHM cm to about 1.0×10¹² OHM cm, at about 23° C. and about 50% relative humidity.

57. The method as defined in claim 55 wherein the resistivity is controlled to a surface resistivity ranging from about 5×10¹² OHM/square to about 1×10¹⁵ OHM/square and a volume resistivity ranging from about 1.0×10¹³ OHM cm to about 1.0×10¹⁵ OHM cm, at about 15° C. and about 10% relative humidity.
